(19) United States
(12) Patent Application Publication
(10) Pub. No.: US 2005/0013135 A1
(43) Pub. Date: Jan. 20, 2005

(54) Sensor lighted bottle cap tunnel

(76) Inventor: Warren Millet, Ridgeland, MS (US)

Correspondence Address: WARREN MILLET, 595 Bryceland Blvd., Ridgeland, MS, 39157, US

(21) Appl. No.: 10/622,153

(22) Filed: Jul. 17, 2003

(51) Int. Cl. F21V 33/00

(52) U.S. Cl. 362/253; 362/101

(57) ABSTRACT

The invention pertains to the use of a bottle cap tunnel that is designed to force a bottle cap to spiral and ricochet back and forth as the bottle cap travels down the bottle cap tunnel. The invention is designed for a novelty. The fact that as the bottle cap travels down the bottle cap tunnel, there are also sets of lights positioned to flash at the same time it takes for the bottle cap to reach the bottom of the bottle cap tunnel. The lighting pattern flashes have several different modes that the consumer can choose by the simple pushing of a momentary switch. This switch is positioned in a manner making it easy for the consumer to choose the lighting pattern desired Several lighting patterns were programmed into the electronic part that instructs the lighting. The invention's new idea creates a novelty for the consumer and has to my knowledge never been invented before.

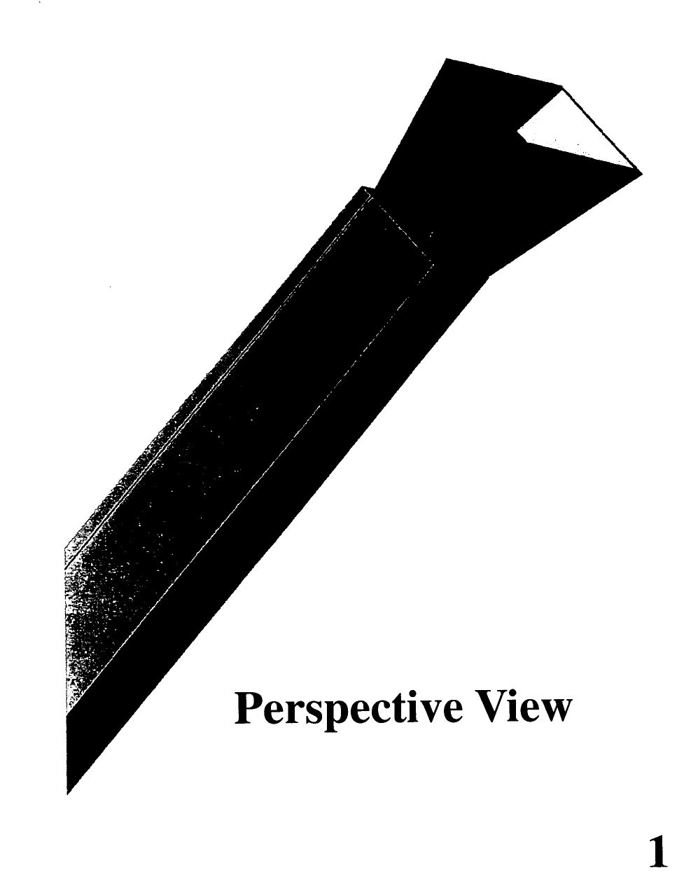

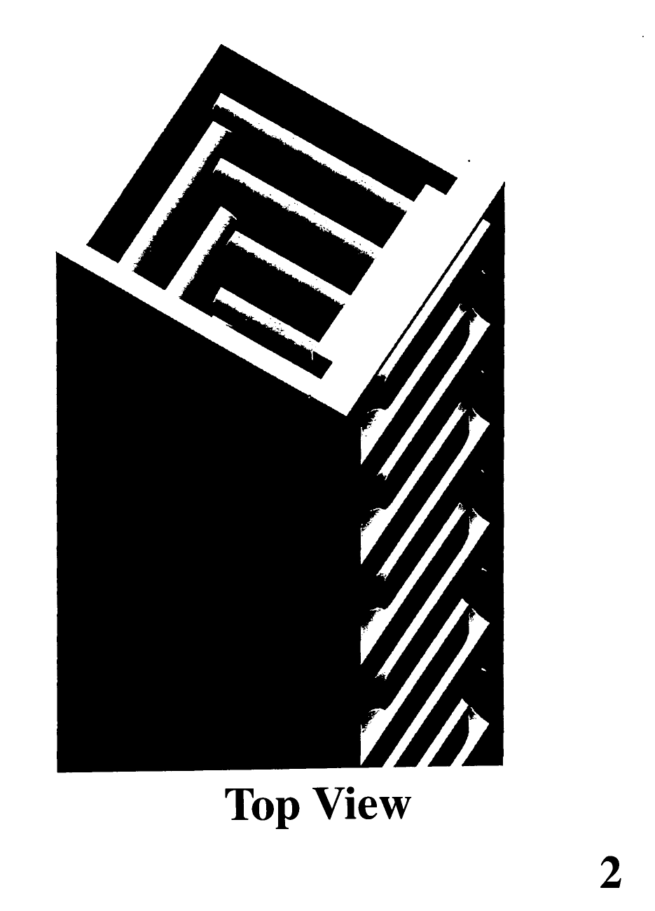

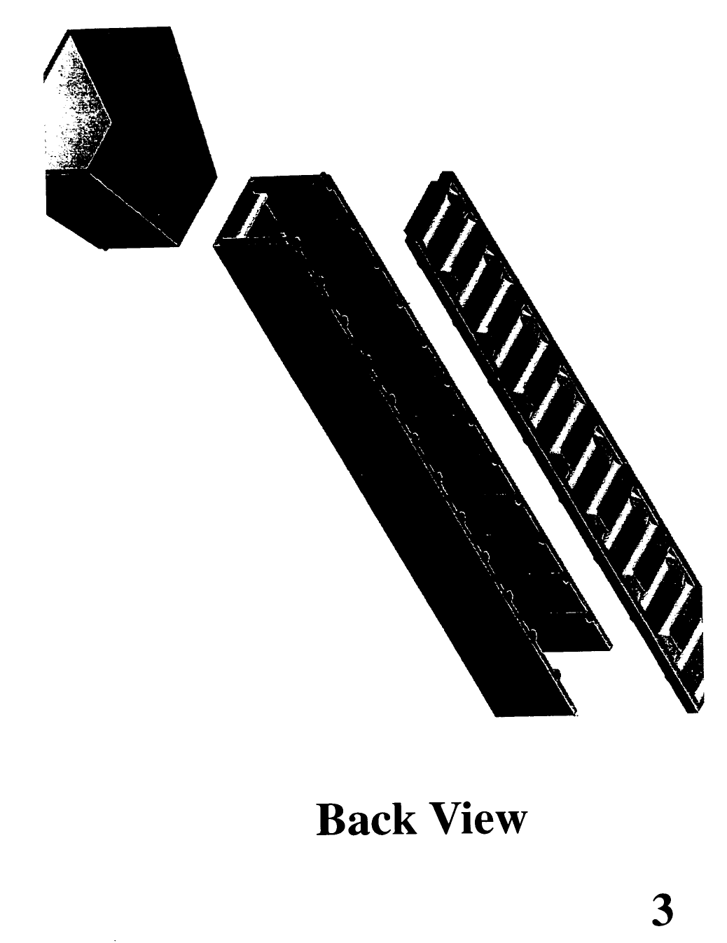

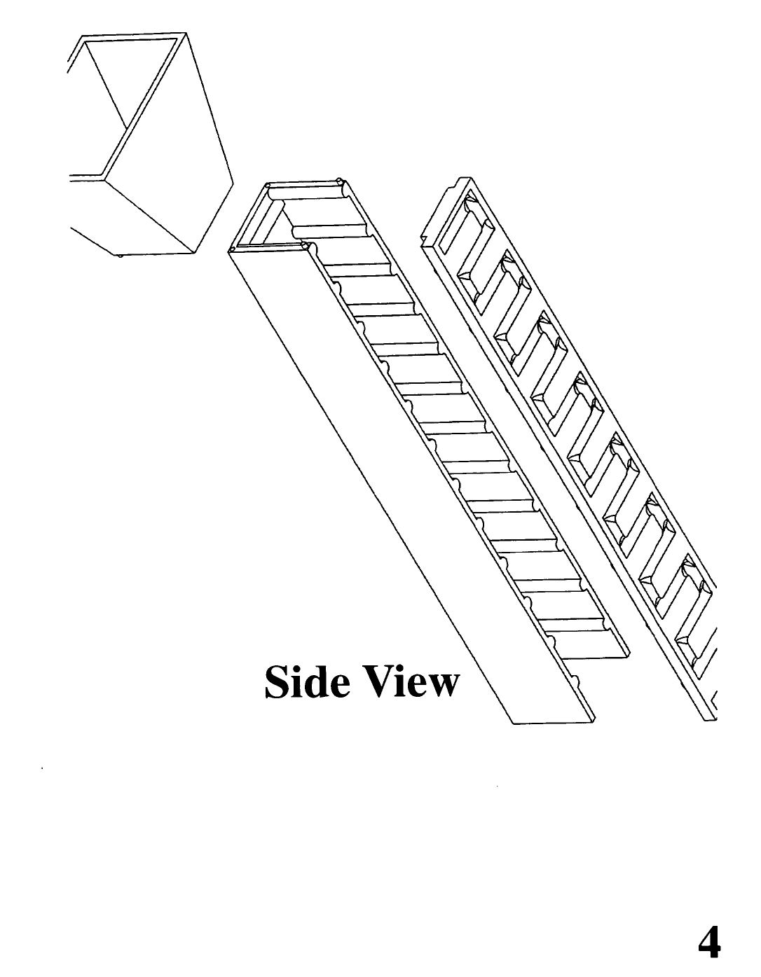

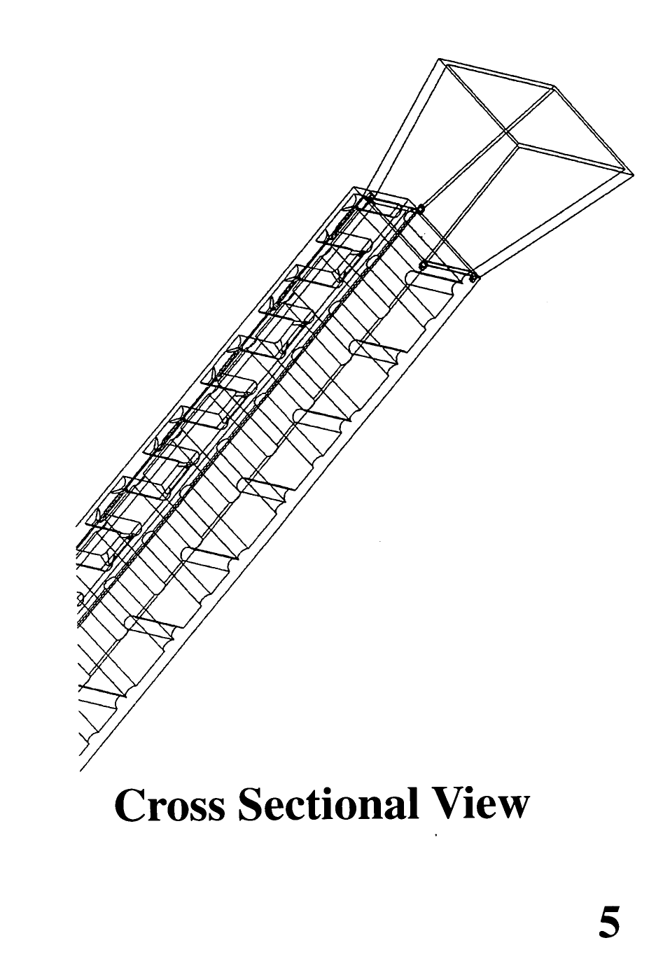

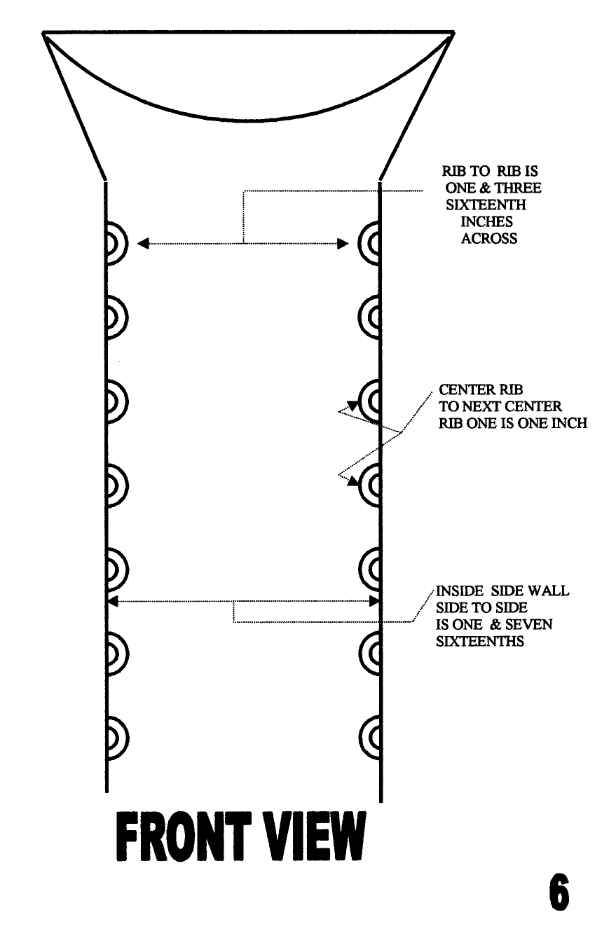

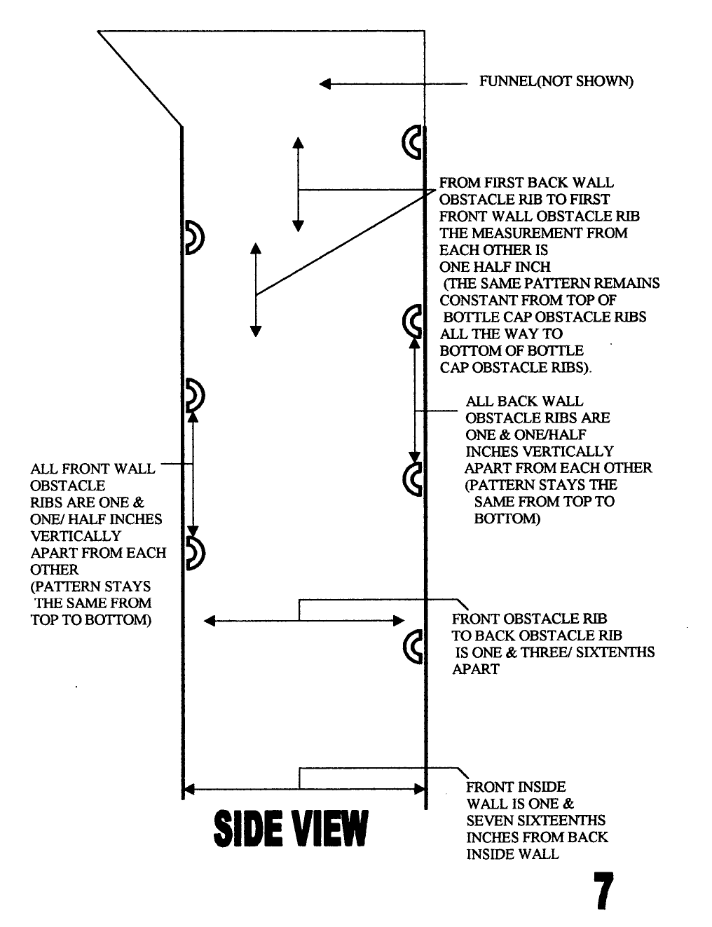

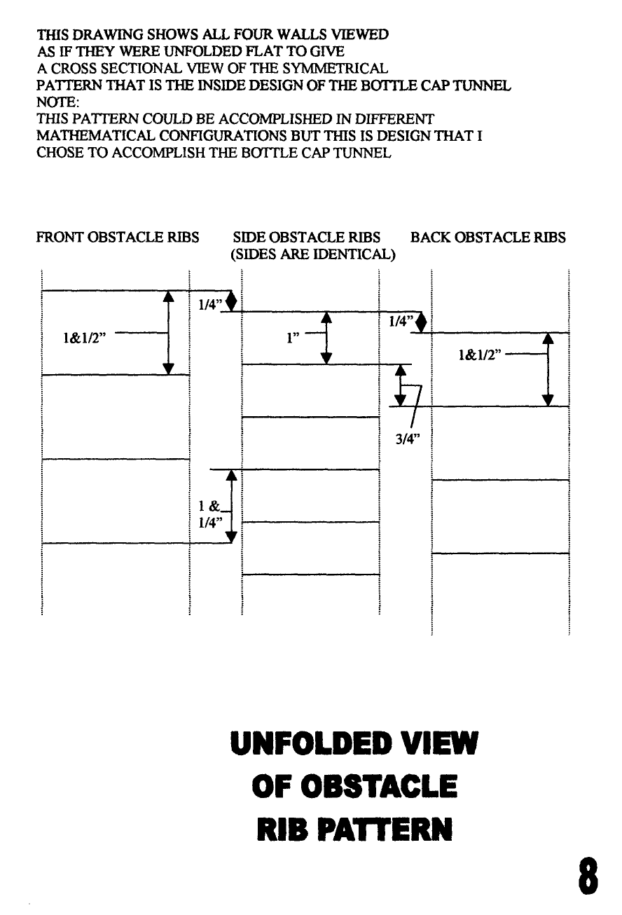

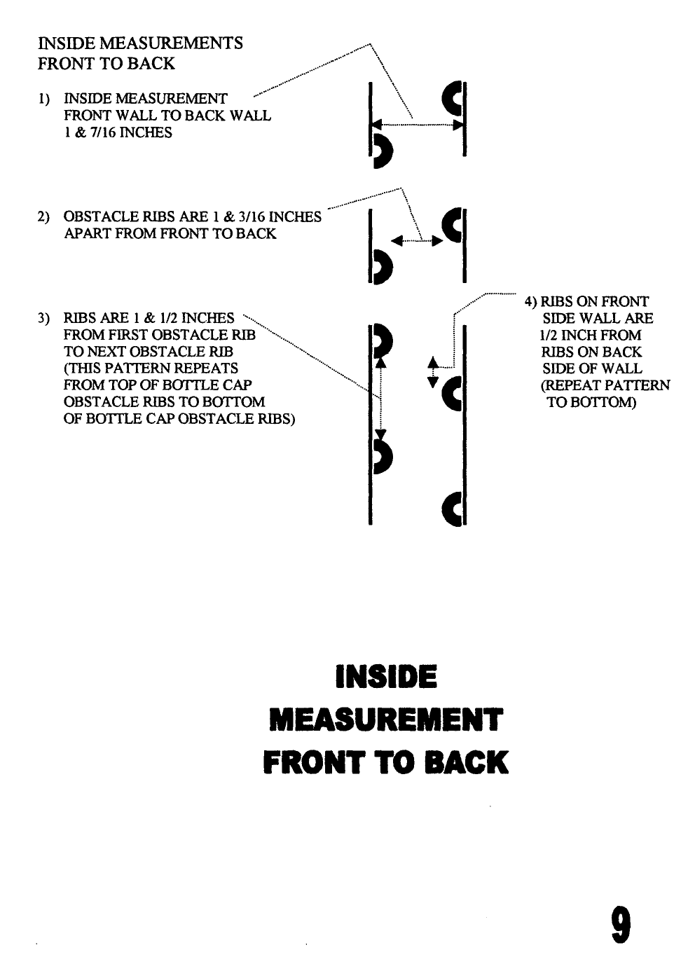

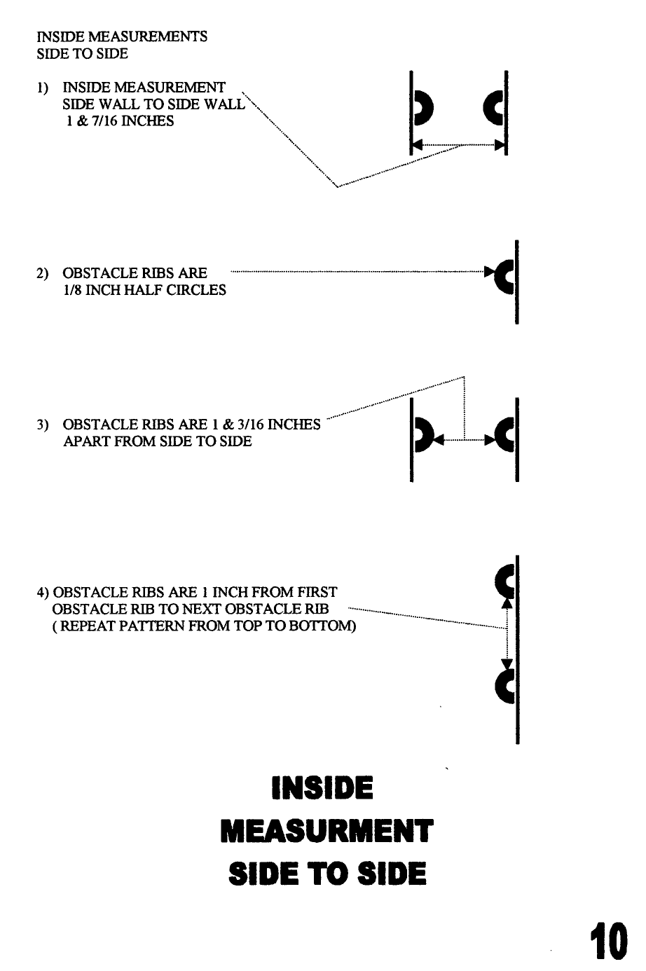

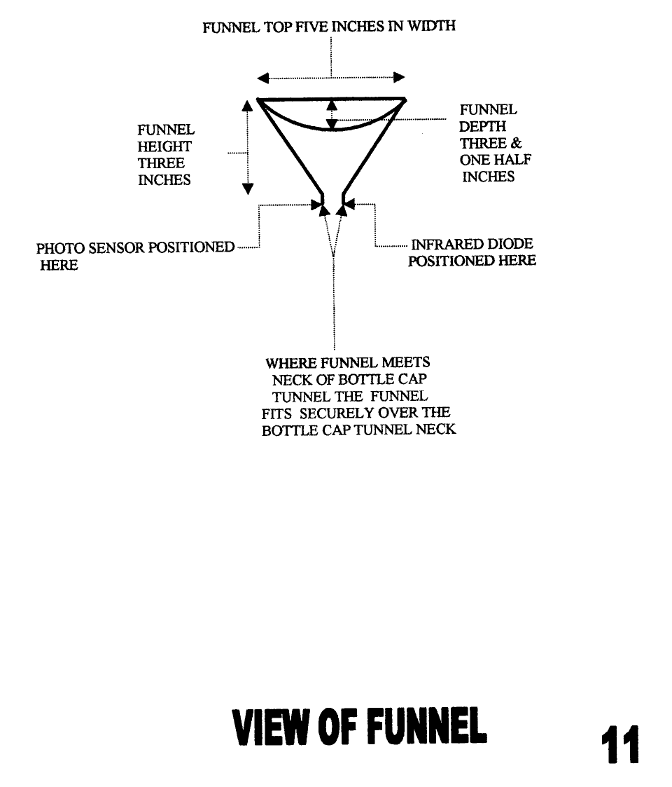

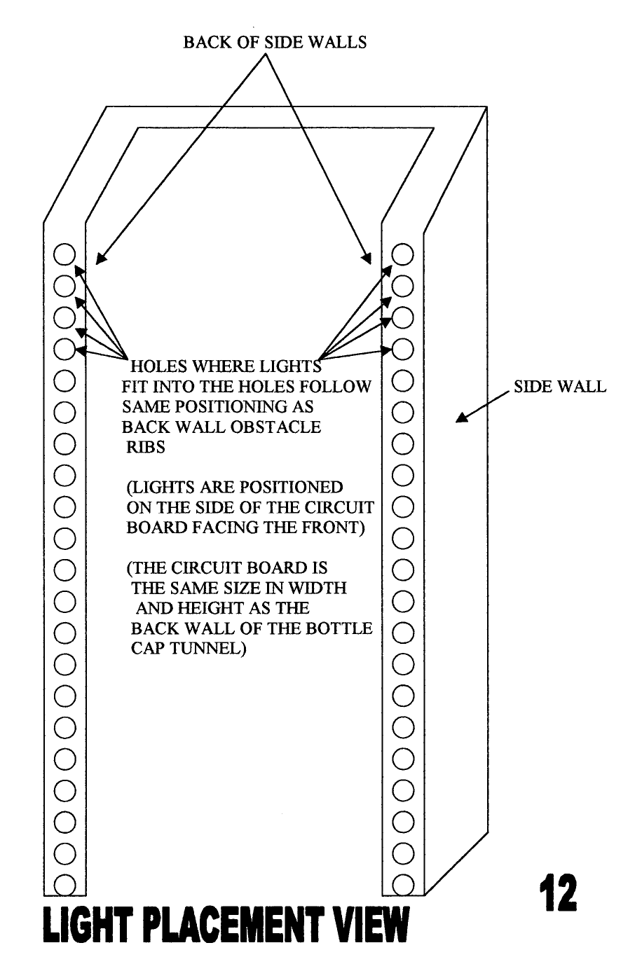

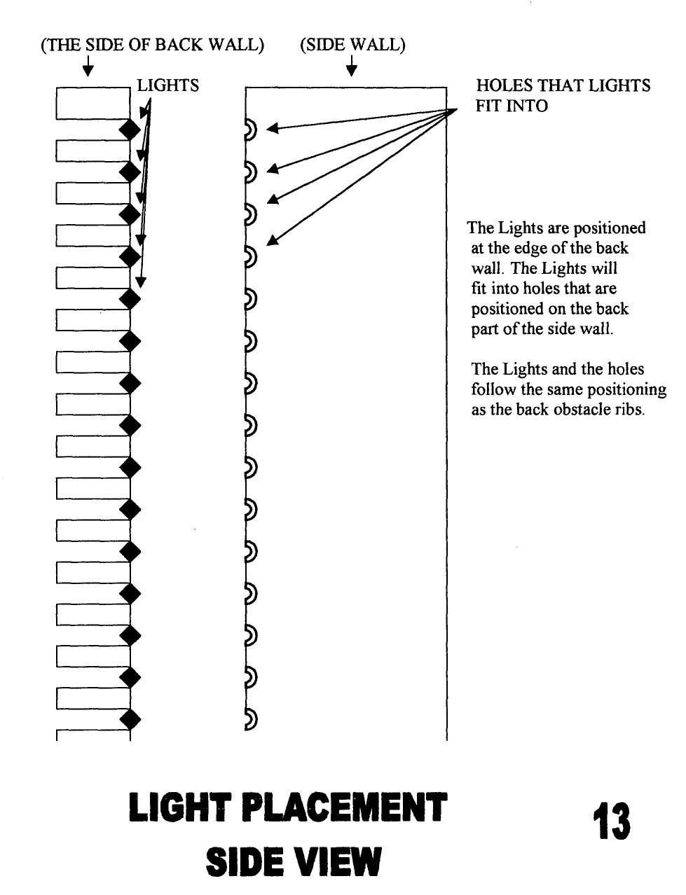

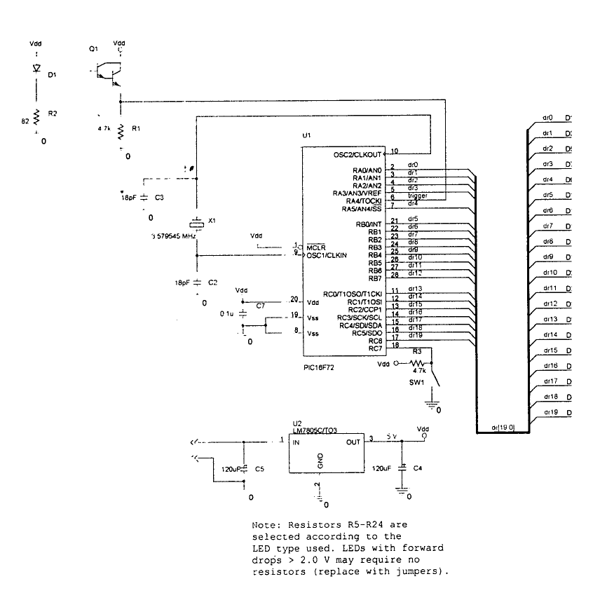

The invention was constructed out of strong material to withstand any normal wear and tear in the use of the invention.

The electronic parts were purchased and then addressed in a manner to create the invention to make it function.

The lighting design and schematic are wired in such a manner as to “flash the lights” emulating the same time it takes for the bottle cap to reach the end of the bottle cap tunnel(Several light patterns).

There are several different lighting patterns that are introduced to make the invention more interesting. As follows:
There is push button switch in which the user can change the mode of the lighting pattern.
The first being a standard pattern following the exact time each obstacle rib is struck be the bottle cap, that particular light will flash and then go off. The last light flashes when the bottle cap strikes the last obstacle rib then that light goes off. So, the lights emulate the same pattern as the bottle cap.
A second being that the lighting pattern starts at the top and flashes two rows at a time emulating the same pattern as the bottle cap.

I have created other lighting patterns as follows:
A third pattern being that the first and last lights positioned on the bottle cap tunnel start flashing in opposite directions meeting in the middle then traveling to the top and bottom of the bottle cap tunnel. The lights then go off when they reach the original starting point.
Other lighting patterns have been addressed into the invention. In, review, I think entering any more lighting patterns for explanation is fruitless because in my opinion, the reader gets the idea that many different lighting patterns can be introduced into the invention without mentioning all of them.

The lighting patterns can be programmed to do any pattern one wishes. The number of lighting patterns is so many that it is senseless to try to mention them all.

I have measured many bottle caps from different distributors and all of them are the same.

This is probably do with the size of the top of the bottle fitting the mouth of a person consuming the product.

So, the inside obstacle ribs of the bottle cap tunnel are a tiny bit further way from each other than the diameter of the bottle cap. Thus, creating a very small space between the bottle cap and the obstacle ribs that the bottle cap has to pass by.

The fact that there is a very small space between the bottle cap and the obstacle ribs, the bottle cap is forced to strike each obstacle rib on the way down the bottle cap tunnel. This symmetrical design causes the bottle cap to spiral and ricochet back and forth as the bottle cap travels down the bottle cap tunnel.

The invention is as follows:
The invention is a sensor lighted bottle cap tunnel.
This application claims priority of application Ser. No. 10/279497 filing date of Oct. 24, 2002.

### CROSS REFERENCE

My other invention's application Ser. No. is 10/279497 applied for Oct. 24, 2002. The new invention has some changes to the first application for the utility patent

1) The first had sound activated lighting only which limited the lighting display. The new additional lighting now has the option to use activated lights that are not sound activated The new lighting also allows the lighting to be activated by different types of sensors. Thus, allowing a much broader margin for different lighting displays to be addressed to the invention.

2) The second part of the added changes is that the new invention has a new concept for the bottle cap tunnel's construction. The first invention had a free standing obstacle bar that slid in and out of the bottle cap tunnel's frame. The new bottle cap tunnel has obstacle ribs that are actually a part of the inside walls of the frame. The measurements for the obstacle ribs are the same as the obstacle bars (first invention) and also have the same positioning in both designs. The reason for the obstacle ribs is to make the invention easy to manufacture. Both the obstacle bars (first invention) and the obstacle ribs (second invention) create the same as and ricochet of the bottle cap as the bottle cap travels down the bottle cap tunnel.

3) The third part of the added changes is that the new invention's frame is different in the following aspect: The first invention had a bottom to the bottle cap tunnel. The second invention has no bottom to the bottle cap tunnel. Thus, allowing the bottle cap to travel down the bottle cap tunnel into a trash box. The trash box can then be dumped into any garbage can. This allows the consumer to enjoy the full benefit of watching the bottle cap travel the same distance every time. The reason is the bottle cap tunnel never gets filled up with bottle caps because it has no bottom.

I am cross referencing this information as stated I am seeking patent protection on both applications.

### BACKGROUND OF THE INVENTION

My invention started out around the beginning of July 2002. I have a patent applied for with the original invention with the United States Patent and Trademark office. (Ser. No. 10/279497) I have made some changes to the original invention. The bottle cap tunnel that had a free standing obstacle bar no longer exists in the second generation model. This particular invention has obstacle ribs that are part of the inside walls of the tunnel. The obstacle ribs were thought of to replace the obstacle bar to make the invention easier to mass produce. This thought came to me around the beginning of January of 2003.

Also the original invention used sound activated lighting which also has some new changes.

This part of the invention came to me around March of 2003. As follows:

I now use sensor lighting that is activated by an infrared light emitting diode.

I also thought of using a microchip that could be programmed to create the lighting design.

This microchip took some time to program to do the function in which I intended

A Compact Disk with the explanation are part of the invention that were thought of in theory.

After proving the theory that the unit did function in the manner that I intended it to, is when I decided to apply for my continuation of the original patent application.

The schematic and explanation included in the package explains how the invention works.

The mechanical specifications are the same as the original invention. As follows:

Basically, the theory of the bottle cap tunnel is the same as the original unit that I constructed.

It works the same as the original model only the second generation will be much easier to mass produce with the obstacle ribs replacing the free standing obstacle bar.

The application of the lighting design is a new idea introduced to the original invention. As follows:

The lighting design that I use in the second generation model is much more appealing and also uses off the shelf parts. But, the thought of how to make the electronic parts function used in my invention came to me around March of the year 2003. I addressed the way that all of these electronic parts function in the manner intended for this invention.

### BRIEF SUMMARY OF THE INVENTION

The bottle cap tunnel mounts wherever easily.

The bottle cap tunnel forces the bottle cap to go into a trash box that holds many bottle caps.

The bottle cap tunnel has novelty in that it creates a fun atmosphere when activated by a bottle cap.

The invention has been tested over and over again and the invention always works.

Any one who chooses to utilize the invention has fun watching the bottle cap descend down the bottle cap tunnel with the lights flashing at the same time the bottle cap strikes each obstacle rib.

### BRIEF DESCRIPTION OF THE DRAWINGS

The invention is a bottle cap tunnel that has obstacle ribs positioned on the four inside walls of the bottle cap tunnel. The obstacle ribs a positioned symmetrically to force the bottle cap to spiral and ricochet down the bottle cap tunnel.

The bottle cap tunnel has a circuit board behind the back wall that has electronic components positioned with a sensor positioned at the top of the bottle cap tunnel. The sensor is activated by the bottle cap breaking the beam of an infrared beam. That sensor then sends a signal to a micro controller. The micro controller then sends a signal to lights that are activated to flash. The flash of the lights emulates the same tune the bottle cap takes to travel down the bottle cap tunnel. The obstacle ribs of the back wall of the bottle cap tunnel have lights on the side of each obstacle rib. As the bottle cap descends down the bottle cap tunnel the lights flash at the same speed. The bottle cap tunnel has no bottom. The bottle cap is forced to go into a trash box. Several light patterns have been addressed to the invention through the micro-controller. The first being the standard: As the bottle cap travels down the bottle cap tunnel the lights flash at each obstacle rib (positioned on each side of each obstacle rib). Each obstacle rib set of lights go on then off in the same time it takes the bottle cap to travel past that particular obstacle rib. (The time is approximately is 0.117 seconds/one tenth and seventeen hundred seconds).

The front and sides of the bottle cap tunnel have strong clear material that allows the bottle cap to be visible as the bottle cap travels down the bottle cap tunnel.

The bottle cap tunnel (funnel part) has a hole where it mounts to any wall or secure surface with a screw. The bottle cap tunnel is thirty three inches in height. The bottle cap tunnel is two and one/quarter inches in width and depth.

### DETAILED DESCRIPTION OF THE DRAWINGS OF THE BOTTLE CAP TUNNEL

The top part(funnel part) measures three inches in height The funnel part measures three and one/half inches in depth. The (funnel part) measures five inches in width.

Where the bottle cap tunnel(neck of bottle cap tunnel) meets the funnel part the bottle cap tunnel is thirty inches in height The bottle cap tunnel is two and one half inches in width and depth

The bottle cap tunnel has no bottom. The bottle cap is forced to go into a trash box.

The measurements are described on pages of drawings.

1) The front side of the inside wall of the bottle cap tunnel has one eight inch obstacle ribs starting at the very top of the bottle cap tunnel(where neck starts). These obstacle ribs are positioned center to center down the bottle cap tunnel's front inside wall every one and one/half inches. This positioning continues all the way down the front inside wall. The count on the front obstacle nibs is twenty one.

2) The back side of the inside wall of the bottle cap tunnel has one eight inch obstacle ribs starting one half inch down from the top of the bottle cap tunnel (where neck starts). These obstacle ribs are positioned center to center down the bottle cap tunnel's back inside wall one and one/half inches. The count on the back obstacle ribs is twenty.

3) The inside wall of both side walls of the bottle cap tunnel both have one eight inch obstacle ribs. The side wall obstacle ribs are positioned center to center down the bottle cap tunnel center to center every one inch. The first obstacle rib of the inside of the side walls are positioned one quarter inch down from the top of the bottle cap tunnel (where neck starts). Both side inside walls of the bottle cap tunnel are a mirror image of each other.

The count on the side obstacle ribs is thirty one.

### DETAILED DESCRIPTION OF THE SPACING BETWEEN OBSTACLE RIBS THE EXPLANATION OF THE DRAWINGS ARE ON DRAWING PAGES

1) The inside wall measurement from the front inside wall to the back inside wall is one and seven/sixteenth inches. Thus, both inside front and back walls have obstacle ribs that are positioned to force the bottle cap to ricochet. So, the measurement from the front inside wall obstacle rib to the back inside wall obstacle rib is one and three/sixteenths inches.

2) The inside wall measurement from the inside wall of the side wall to the other inside wall of the side wall is one and seven/sixteenths inches. Thus, both inside side walls have one/eight inch obstacle ribs that are positioned to force the bottle cap to spiral. So, the measurement from the side obstacle rib to the other side obstacle rib is one and three/sixteenth inches.
NOTE: THE ABOVE MEASUREMENTS CREATE AND OPEN AREA OF ONE AND THREE SIXTEENTHS INCHES. ALL STANDARD BOTTLE CAPS ARE ONE AND ONE EIGHT INCHES IN DIAMETER THIS OPEN AREA CREATED BY THE MEASUREMENTS FROM ALL FOUR SIDES OF THE OBSTACLE RIBS CREATES A VERY TINY SPACE FOR THE BOTTLE CAP TO PASS BY. THIS TINY SPACE FORCES THE BOTTLE CAP TO STRIKE EACH OBSTACLE RIB AS IT TRAVELS DOWN THE BOTTLE CAP TUNNEL.

### DESCRIPTION OF HOW THE ELECTRONICS FUNCTION IN RELATIONSHIP TO THE BOTTLE CAP TUNNEL

The light display is an array of lights arranged in twenty rows corresponding to the twenty back wall obstacle ribs of the bottle cap tunnel. The lights flash on and off in sequence starting at the top of the bottle cap tunnel tracking the bottle cap as it falls through the tunnel. A micro controller (MCU) controls the lighting sequence and timing. A sensor is positioned just above the first back obstacle rib. This sensor triggers the start of the lighting display sequence. The bottle cap falls through an infrared beam causing the receiving sensor to send a trigger pulse to the micro controller telling the micro controller to start the lighting sequence. The lighting sequence takes about two and four tenths seconds to complete. Upon completion with no bottle caps in the bottle cap tunnel, a finale display is initiated lasting about one second. A mode switch positioned on the bottle cap tunnel allows the user to change the lighting display sequence.

1) The first style is the standard lighting display. The lighting display travels at the same speed down the bottle cap tunnel. The last light goes off when the bottle cap reaches the end then into a trash box.

2) The second being two rows at a time to create the same pattern as the first style lighting display.

3) The third being that the first and last start going opposite directions meeting in the middle and then going on to the very top and bottom of the bottle cap tunnel. The lights go off when they reach their original starting point.

4) The fourth being that the first goes off, then the third, back to the second, then to the fourth obstacle rib. The pattern goes on until the bottle cap reaches the bottom then the last lights go off.

5) There are other lighting patterns but I feel it is insignificant to mention them all.
NOTE: THE INVENTION COULD BE DONE WITH VARIOUS MEASUREMENTS ON THE BOTTLE CAP TUNNEL AND ALSO USING A DIFFERENT ELECTRONIC DESIGN. I INVENTED THE BOTTLE CAP TUNNEL UNIT USING THESE PARTICULAR MEASUREMENTS AND ELECTRONIC DESIGN TO MAKE THE UNIT EASY TO MANUFACTURE.
   Circuit Description

The light display consists of twenty rows of LEDs (Light Emitting Diodes) placed so as to align with the twenty deflection ribs on the backside of the bottle cap tunnel. The lights turn on and off in a prescribed pattern that is synchronized to the position of the bottle cap as it falls though the tunnel. Five different light sequence patterns are selectable from a push button switch. The light pattern sequence begins when the bottle cap enters the top of the tunnel and upon exiting the bottom of the tunnel, a final short display pattern sequence is initiated.

The bottle cap entry into the top of the tunnel is sensed by a phototransistor and infrared LED (Q1 and D1 in the schematic diagram). The bottle cap momentarily interrupts the infrared light path causing the phototransistor Q1 to send a short pulse to the microcontroller chip. The microcontroller performs the complete control of the light pattern sequences and acts as the central “brain” of the light display system. A program in the microcontroller monitors the sensor input from Q1 and initiates and controls the light pattern sequence when a sensor signal is present. Twenty microcontroller output pins drive the twenty LED rows, supplying source current to the LEDs causing them to light. The accurate timing of the lighting sequence is achieved by an internal (to the microcontroller) clock generator using an external 3.579545 MHz quartz crystal, X1, as the resonator for the clock oscillator.

The microcontroller, phototransistor, and all LEDs operate from a 5 V (Volt) regulated power source provided by a 5 V regulator IC (Integrated Circuit). The Light display system requires an unregulated 9 V DC power source. Any commercially available 110 V AC to 9 V DC adapter capable of supplying 1 A (Ampere) of current is adequate for this purpose.

Other Implementations of the Light Display

The light display system can be implemented with various choices of components to accomplish the same effects. The photo-sensor may be replaced with any suitable proximity detector for the purpose of detecting the bottle cap. Incandescent light sources or fluorescent light displays could be substituted for the LEDs with the use of an appropriate driver IC. The microcontroller IC could be replaced with a custom ASIC (Application Specific Integrated Circuit) or with multiple SSI (Small-Scale Integration) ICs to implement the required controlling functions.

1. What I claim as my invention is a sensor activated lighted bottle cap tunnel with obstacle ribs:
All of the materials that were used for my invention were purchased by myself.
The idea and time spent on the unit are my own with help from no one.
The products used to construct my invention have been invented before, but in the manner in which I used all materials gave me the aid in the creation of my invention.
I claim that all of the construction was completed by myself.
In the manner of the way the unit does function, all of the materials that were used are necessary for the invention.
I have searched and found no other sensor activated lighted bottle cap tunnel with obstacle ribs.
I claim my invention is a first and seek protection on the concept, construction, function, and the manner in which the following listed numbered items operate the unit. I also address that these listed items can be in many different mathematical measurements. I am seeking protection that the invention may be constructed from the items listed below in different mathematical configurations. I hope to protect the utility patent application as applied for.
List as Follows:
1. THE FRAME OF THE INVENTION—ANY STRONG MATERIAL MAY BE USED. The way the frame functions as stated previously that this is different from any other.
2. THE OBSTACLE RIBS THAT ARE PART OF THE INSIDE WALLS—ANY STRONG MATERIAL MAY BE USED. The way the obstacle ribs function there has been none ever used before for a bottle cap tunnel.
3. THE LIGHTING DESIGN AND SCHEMATIC WITH THE ELECTRONIC COMPONENTS. No other sensor activated lighted bottle cap tunnel has ever been invented before m the manner in which my sensor activated lighted bottle cap tunnel functions.
My invention of the sensor lighted bottle cap tunnel takes a new step in the field of technology. Other “bottle cap catchers” that I have seen and reviewed either through use of the “web” or other methods have been virtually produced the same results. Most bottle cap catchers that I have reviewed are not anything close to what I have invented. I have reviewed the plain “box” type looking bottle cap catchers and one that was a bottle cap catcher magnet.
The fact that I have addressed much time and effort into this invention I think that the way the invention operates it creates a novelty and utility for consumers to utilize.
Other than a few bottle cap catchers I have reviewed have no novelty to them what so ever.
The lights flashing creates a fun atmosphere for the consumer.
The fact that the lighting pattern can be adjusted by a consumer and the bottle cap having to strike obstacle ribs “clanking back and forth” on it's way down the bottle cap tunnel is a brand new idea that I have not seen any where.
This invention is a continuation on a previous application. As stated in the background of the invention, I would like to keep the previous application up for your panel to review. That application Ser. No. is 10/279497. I applied for this application on Oct. 24, 2002.
I am seeking a new patent application number for this invention.
I am seeking protection from the United States Patent and Trademark Office on this brand new information included in the plastic envelope.
